(19) United States
(12) Patent Application Publication
(10) Pub. No.: US 2014/0100863 A1
(43) Pub. Date: Apr. 10, 2014

(54) Medical Benefits Determination System and Related Methods

(71) Applicant: Constantine Mantz, Fort Meyers, FL (US)

(72) Inventor: Constantine Mantz, Fort Meyers, FL (US)

(21) Appl. No.: 14/023,261

(22) Filed: Sep. 10, 2013

Related U.S. Application Data
(60) Provisional application No. 61/698,753, filed on Sep. 10, 2012.

(51) Int. Cl. G06F 19/00

(52) U.S. Cl. CPC G06F 19/328
USPC 705/2

(57) ABSTRACT

A computer-based system and method for determining clinical appropriateness and medical benefits for one or more proposed specific medical management of a medical condition, and the reporting of procedural and cost-related information for the same.

### CROSS-REFERENCE TO RELATED APPLICATION

This application claims the benefit U.S. Provisional Patent Application Ser. No. 61/698,753, filed Sep. 10, 2012, the contents of which are incorporated by reference herein.

### FIELD OF INVENTION

The present invention generally relates to the field of health insurance systems, and more particularly, to automated medical benefits determination networks and related methods.

### BACKGROUND OF THE INVENTION

Health insurers and their contracted benefits managers utilize predefined medical policies as the basis for determining potential coverage of healthcare services for beneficiaries. Some healthcare services (a.k.a “benefits”) require approval by the insurer before healthcare provider is authorized to render such services to a patient policyholder. This advance approval of services (a.k.a “authorization” or “pre-authorization”) is commonly required for elective surgeries and other costly procedures. For the insurer, the pre-authorization process serves to control healthcare expenditures to themselves and to their beneficiaries by informing providers that certain medical procedures are not covered by their medical policy for payment purposes. For the provider, authorization of services is a de facto guarantee from the insurer that medical procedures will be paid.

A medical policy is a statement of the clinical practices/procedures utilized by the insurer that defines the standards of care in the medical management of a defined health condition. For example, a medical policy may state that either surgery or radiation therapy is an appropriate treatment for prostate cancer. A medical policy may additionally enumerate therapeutic options considered experimental and therefore deemed inappropriate as treatment for a particular health problem. Furthermore, a medical policy may also describe conditionally appropriate treatment choices that are considered appropriate only when specified patient or disease factors are present. To substantiate claims of appropriateness of care, medical policies reference multiple number of resources, including treatment guidelines developed by consensus expert groups and published medical literature.

To process service authorization requests, insurance companies typically utilize nurses and staff with medical experience to evaluate their medical policies against clinical information received from healthcare providers. A typical pre-authorization procedure begins with the provider completing a form containing details of a patient's specific health condition in addition to information regarding the patient's general health. The form may either be completed manually and submitted to the requesting authority by fax or electronically and submitted through the Internet. The insurer's staff reviews this information and evaluates the requested services based on what is allowable by the medical policy for the stated diagnosis and other health factors. The staff then makes a determination of allowed services and issues a written decision to the healthcare provider. If a determination cannot be made due to missing or conflicting information, then the insurer may request additional details from the provider. In the case of a denial of requested services, then the provider may request a peer-to-peer challenge of the decision to address special circumstances that may support approval of such denied services. In this situation, the provider discusses the case directly with a skilled medical expert retained by the insurer, and the expert would inform the insurer of any recommendation to authorize or not authorize the requested services.

At present, case data and requested services are reviewed and authorization decisions rendered entirely by staff members. This requires simultaneously consideration of clinical information about the case, the insurer's specific medical policy, requested medical services, and specific coding and billing rules that apply to such services. Case information is routinely populated with uncommon and sometimes ambiguous medical terms, which may be misunderstood by a reviewer disconnected from the clinic experience. Likewise, medical policy language is often highly technical, legalistic, and complex. Furthermore, coding and billing rules governing proper reporting of medical services to the insurer add additional complexity to the process. The reviewer may need to query multiple sources to obtain these rules—including the American Medical Association's Common Procedural Terminology Manual, coding guidebooks published by medical specialty organizations, and the insurer's own coding policies. The rules themselves are also often subject to various conditions and exceptions.

The example below illustrates a complex set of relationships among codes that an authorization reviewer must consider in making a determination of benefits for a course of care:
Service A and Service B are medical services requested for authorization by a healthcare provider for treatment of a patient with a given diagnosis
Service A and Service B represent separate and different medical procedures, but both need to be performed to provide a complete treatment for the diagnosis per specialty organization guidelines.
The provider also requests authorization for Service C. Service C is an ancillary medical service to the performance of Services A and B and is recommended per specialty guidelines.
However, the Common. Procedural Terminology Manual defines Service C as bundled with Service A and therefore not entitled to a separate payment when performed in combination with Service A.
The Manual does not define Service C as bundled with Service B and therefore supports a separate payment for Service C when performed together with Service B.
Furthermore, the insurer's medical policy allows for a maximum of 5 units of Service C to be reported for payment for every week of care during which Service B is performed.

As exemplified, the demands upon a reviewer to make an accurate determination, of benefits can be challenging. Currently, success at this point is largely result of an individual reviewer's judgment, which in turn depends upon clinical experience and knowledge, grasp of coding rules, and attentiveness to case details.

Because judgment and expertise varies across reviewers and can even vary across time for a particular individual due to motivation, experience, and other poorly defined factors-authorization results may be inconsistent among similar cases. Additionally, complex considerations of benefits, as illustrated in the above example, may require significant time for careful review to render an accurate decision. As such, the process often produces significant delays between requests and subsequent service authorizations. Although not problematic for elective surgeries and other procedures, delays in care may significantly compromise clinical outcomes for patients with cancer and other time-critical conditions that require immediate medical management.

As accumulating research evidence attests to the value of new methods and technologies for the treatment of a given disease, medical specialty societies and multispecialty consensus groups update treatment guidelines that often include new therapies and standards of care. Similarly, the American Medical Association and other entities periodically review reporting rules for procedural codes and issue updates to established coding policies. These updates occur a continuous basis—sometimes without broad announcement—and therefore create challenges for the insurer or benefits manager to maintain their own practice policies accordingly.

A related and ongoing challenge relates to the retraining of reviewers in light of continually evolving policy and to update training materials for new hires. As with the authorization review process, maintenance of company policy and training materials is highly dependent on multiple individuals and their individual skill sets and motivation.

Other limitations of the process pertain, to the actual reporting of authorized benefits to the provider. The insurer may authorize a set of medical services for a given case, yet the associated authorization, statement is often incomplete. In particular, every defined and billable service that should be appropriately rendered during the diagnosed course of care should be reflected on the authorization statement, yet this is often not the case Some medical conditions, such as cancer, require a large number of distinct services as defined by the Common Procedural Terminology Manual and with a variable number of units for each service. Many services are ancillary to the performance of the main medical service that is considered for authorization. For example, a surgical procedure may require separately billable, services such as ultrasound or x-ray imaging to be performed at the time of the operation to assist the surgeon. Given the difficulties for reviewers to interpret medical records and policies, insurers generally choose to limit their authorization efforts to one or a few medical services, totally avoiding consideration of ancillary, yet necessary, services. As a result, unnecessary procedures may be inappropriately performed, or the provider is denied payment by the insurer for appropriately performing services that were not explicitly authorized. In either event, administrative burden is created in order to reconcile contested claims.

Other reporting limitations include a dearth of disclosing resources used by insurers in supporting authorization decisions. The additional lack of and other information such as comparative clinical practice statistics precludes a requesting provider analyze management strategy against other practices. Again, insurers are limited or unable to provide case-specific references to particular materials used in the adjudication of a given authorization.

### SUMMARY

In view of the foregoing, an object of the present invention is to provide a medical benefits determination system that comprises rules engine sets to perform, inter alia, the following functions: (1) coverage determination for requested medical services; (2) primary and ancillary medical services determination for the appropriate management of a diagnosis; (3) calculation of the appropriate service units per authorized medical benefit; (4) cost calculation for each medical benefit and for the entire set of benefits for an authorized, course of care; (5) calculation of a “Clinical Appropriateness Score” for the requested service(s) in order Co permit comparisons against other possible medical management strategies for the same diagnosis; (6) generation of a “Medical Recommendations Summary” (“MRS”) report for Che provider and insurer to provide a summary of the standards of medical management for a particular diagnosis, comparisons of the requested services against such standards, and a list of medical literature and consensus group references supporting the summary; (7) generating a “Coding Summary” report for the provider and insurer to provide a list of authorized benefits and their corresponding units of service along with notes/commentary on the correct reporting practices with references to authoritative coding guidelines and manuals; and (8) generation of a graphical display of the cost and Clinical Appropriateness Score for the requested service, as well as of the costs and Clinical Appropriateness Scores of other medically indicated services for the same diagnosis for comparative and strategic purposes. The rules engines that govern the above functions may be customized and adapted to any policy of medical coverage or coding practice.

According to an aspect of the present invention, a computer-based system for reporting procedural and cost-related information for at least one proposed specific medical management of a medical condition comprises at least one network-connected computer including a processor and machine readable memory configured to perform one or more of the following: receive one or more patient information variable, the patient information variable including at least the medical condition and the one or more proposed specific medical management; query a database comprising pre-defined clinically appropriate medical managements for the medical condition, the pre-defined clinically appropriate medical managements including at least an appropriateness score; associate patient information variable(s) with e or more pre-defined clinically appropriate medical managements to determine one or more appropriate medical procedure for rendering a one or more proposed specific medical management and/or to assign a status indicator to the specific medical management; associate one or more valuation information with the one or more appropriate medical procedure to obtain a procedure cost; assign an appropriateness score to the specific medical management based on the status indicator and the pre-defined clinically appropriate medical managements; associate the patient information variable, the pre-defined clinically appropriate medical managements, and the appropriateness score to determine one or more appropriate medical procedure for rendering a one or more proposed specific medical management; query the database for clinical statement related to the appropriateness score and the one or more proposed specific medical management; and query the database for and displaying one or more billing procedures based on the procedure cost and/or one or more medical reference supporting the clinical statement.

According to a method aspect, computer-based method for determining clinical appropriateness of one or more proposed specific medical management for a medical condition is executed by at least one network-connected computer including a processor and machine readable memory. The method includes one or more of the steps of receiving one or more patient information variable, which includes the medical condition and the one or more proposed specific medical management; querying a database comprising pre-defined clinically appropriate medical managements for the medical condition, the pre-defined clinically appropriate medical managements including a pre-defined appropriateness score; associating the pre-defined clinically appropriate medical managements with the one or more proposed specific medical management to assign a status indicator to the one or more proposed specific medical management; and assigning an appropriateness score to the one or more proposed specific medical management based on criteria comprising the status indicator and pre-defined clinically appropriate medical managements.

One of the status indicators is whether the one or more proposed specific medical management is approved, and the database is queried for the pre-defined clinically appropriate medical management to assign pre-defined appropriateness score to the one or more proposed specific medical management if the one or more proposed specific medical management is approved. Also, the database may be queried for alternative pre-defined clinically appropriate medical managements for the given medical condition to display the alternative pre-defined clinically appropriate medical managements and corresponding pre-defined appropriateness scores as additional treatment options. The appropriateness score(s) assigned to the proposed specific medical management(s) may additionally be displayed.

Another status indicator is whether the one or more proposed specific medical management is denied. As such, the database is queried for pre-populated statements of denial and pre-populated statements of denial are displayed.

In some embodiments, the method further includes querying the database for one or more medical procedures associated with a proposed specific medical management (or alternatively, alternative pre-defined clinically appropriate medical managements) and di-playing the medical procedure(s). Furthermore, method may include associating one or more valuation information with the one or more medical procedures associated with the one or more proposed specific medical management to obtain one or more procedure cost, and/or associating the valuation information with the medical procedure(s) associated with alternative pre-defined clinically appropriate medical managements to obtain one or more alternative procedure cost.

According to a further method aspect, a computer-based method for determining medical benefits necessary for the treatment of a medical condition and for reporting procedural and cost-related information for a proposed specific medical management of a medical condition is executed by at least one network-connected computer including a processor and machine readable memory. The method includes one or more of the steps of: receiving one or more patient information variable, the patient information variable including at least the medical condition and the one or more proposed specific medical management; querying a database comprising pre-defined clinically appropriate medical managements for the medical condition, the pre-defined clinically appropriate medical managements including at least an appropriateness score; associating the patient information variable(s) with one or more pre-defined clinically appropriate medical managements to determine one or more appropriate medical procedure for rendering a one or more proposed specific medical management and/or to assign a status indicator to the specific medical management; associating one or more valuation information with the one or more appropriate medical procedure to obtain a procedure cost; assigning an appropriateness score to the specific medical management based on the status indicator and the pre-defined clinically appropriate medical managements; associating the patient information variable, the pre-defined clinically appropriate medical managements, and the appropriateness score to determine one or more appropriate medical procedure for rendering a one or more proposed specific medical management; querying the database for a clinical statement related to the appropriateness score and the one or more proposed specific medical management; associating one or more valuation information with the one or more appropriate medical procedure to obtain procedure cost; and querying the database for and displaying one or more billing procedures based on the procedure cost and/or one or more medical reference supporting the clinical statement.

In some embodiments, the procedure cost includes total costs associated with all of the appropriate medical procedure(s) for rendering the proposed specific medical management(s). Likewise, the method further includes displaying the appropriate medical procedure(s) and associated procedure cost(s) for rendering the proposed specific medical management(s) appropriate medical procedure(s) include, but are not limited to, pre-treatment procedures, intra-treatment procedures, post-treatment procedures, and combinations thereof.

These and other objects, aspects and advantages of the present invention will be better appreciated in view of the drawings and following detailed description of preferred embodiments.

### BRIEF DESCRIPTION OF THE DRAWINGS

FIG. 1 is a schematic overview of a medical benefits determination system, according to an embodiment of the present invention;

FIG. 2 is a flow diagram illustrating an embodiment of a medical benefits determination system; and

FIG. 3 is a flow diagram of a method for determining medical benefits, and reporting of same, according to a method aspect of the present invention.

Like reference numerals refer to like parts throughout the several views of the drawings.

### DETAILED DESCRIPTION OF EMBODIMENTS

Reference is made to particular features (including method steps) of the invention. It is to be understood that the disclosure of the invention in this specification includes all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

The terminology used herein is for the purpose of describing particular embodiments only and is not intended to be limiting of the invention. As used herein, the indefinite articles “a”, “an” and “the” should be understood to include plural reference unless the context clearly indicates otherwise.

The phrase “and/or,” as used herein, should be understood to mean “either or both” of the elements so conjoined, i.e., elements that are conjunctively present in some cases and disjunctively present in other cases.

As used herein, “or” should be understood to have the same meaning as “and/or” as defined above. For example, when separating a listing of items, “and/or” or “or” shall be interpreted as being inclusive, i.e., the inclusion of at least one, but also including more than one, of a number of items, and, optionally, additional unlisted items. Only terms clearly indicated, to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

The term “comprises” is used herein to mean that other elements, steps, etc. are optionally present. When reference is made herein to a method comprising two or more defined steps, the steps can be carried out in any order, or simultaneously (except where the context excludes that possibility), and the method can include one or more steps which are carried out before any of the defined steps, between two of the defined steps, or after all of the defined steps (except where the context excludes that possibility).

As used herein, the terms “including”, “includes”, “having”, “has”, “with”, or variants thereof, are intended to be inclusive similar to the term “comprising.”

In this section, the present invention will be described more fully with reference to the accompanying drawings, in which embodiments of the invention, are shown. This invention may, however, be embodied in many different forms and should not be construed as limited to the embodiments set forth herein. Rather, these embodiments are provided so that this disclosure will be thorough and complete, and will convey the scope of the invention to those skilled in the art.

The present invention is directed to a system and related methods for deriving a complete determination of medical benefits for treatment and management of a given diagnosis or medical condition following the input of one or more patient information variable, such as disease and other pertinent variables. The invention also prepares and produces statements and statistics pertaining to the clinical appropriateness and cost of a requested set of medical services for the management of a given diagnosis and therefore serves as a clinical decision support tool for a medical services provider.

The present invention provides a medical benefits determination system, and related methods, capable of rapidly adapting and applying changes in medical and coding policy and for preparing and presenting appropriate therapeutic alternatives to denied services and for tracking and reporting provider statistics of requested services and outcomes of the authorization process, reducing administrative burden over disputed insurance claims and enhancing the knowledge base of providers, thus supporting the delivery of high-quality healthcare.

The invention preferably comprises software stored and run/executed by a computing device such as a general-purpose computer system (e.g. personal computer) comprising a processor, memory, data storage device, input devices and output devices. Examples of such a system include, without limitation, desktop, notebook, tablet computing device, smart phone, and any other computing device known in the art. The device is preferably networked with data and/or program servers through local or wide area networks, including wireless and cellular networks. The system may, in one embodiment, provide an interface for the healthcare provider to input clinical data about a patient, but preferably the healthcare provider can only receive health information from user interfaces capable of transferring data according to Health Level Seven (HL7) and other healthcare informatics interoperabilty standards known in the art.

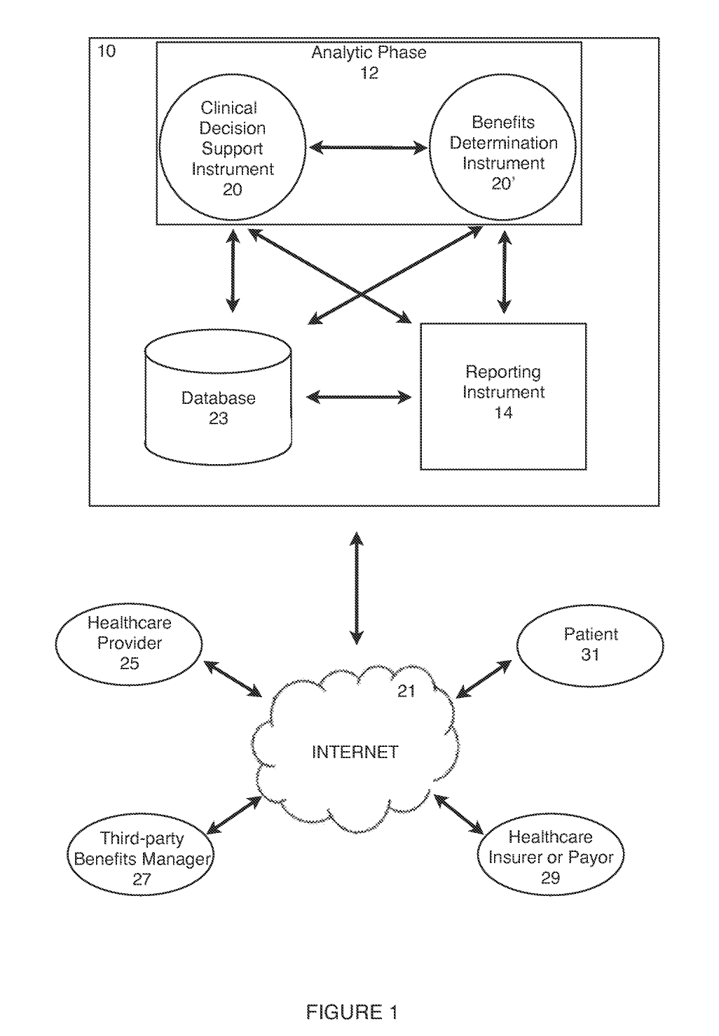

With reference initially to FIG. 1, one embodiment of the medical benefits determination system 10 (“system” or “the system”) comprises separate software modules that perform specific functions and can operate independently of each other in the performance their respective functions. The components interface with each other in an iterative fashion, as the output of one component serves as the input for another component. The separate components of the invention include (1) a Clinical Decision Support Instrument 20 to determine either approval or denial of a requested medical service and to assign a clinical appropriateness score for an approved medical service relative to other services; (2) a Benefits Determination Instrument 20′ to determine the specific medical procedures and their corresponding units of service to render a medical service approved per the Clinical Decision Support Instrument 20; and (3) a Reporting Instrument 14 to produce a fully described output of the approved medical service and its related procedures with supporting references from the medical literature, coding and billing guidance and other pertinent clinical and cost information. The Clinical Decision Support Instrument 20 and Benefits Determination instrument 20′ collectively make up the analytic phase 12 of the system.

Each of the modules of the system 10 collectively, and/or independently, communicates with one or more database 23. The system 10 further communicates with the internet 21 to provide access to a healthcare provider 25, third-party manager 27, healthcare insurer or payor 29 and/or patient 31.

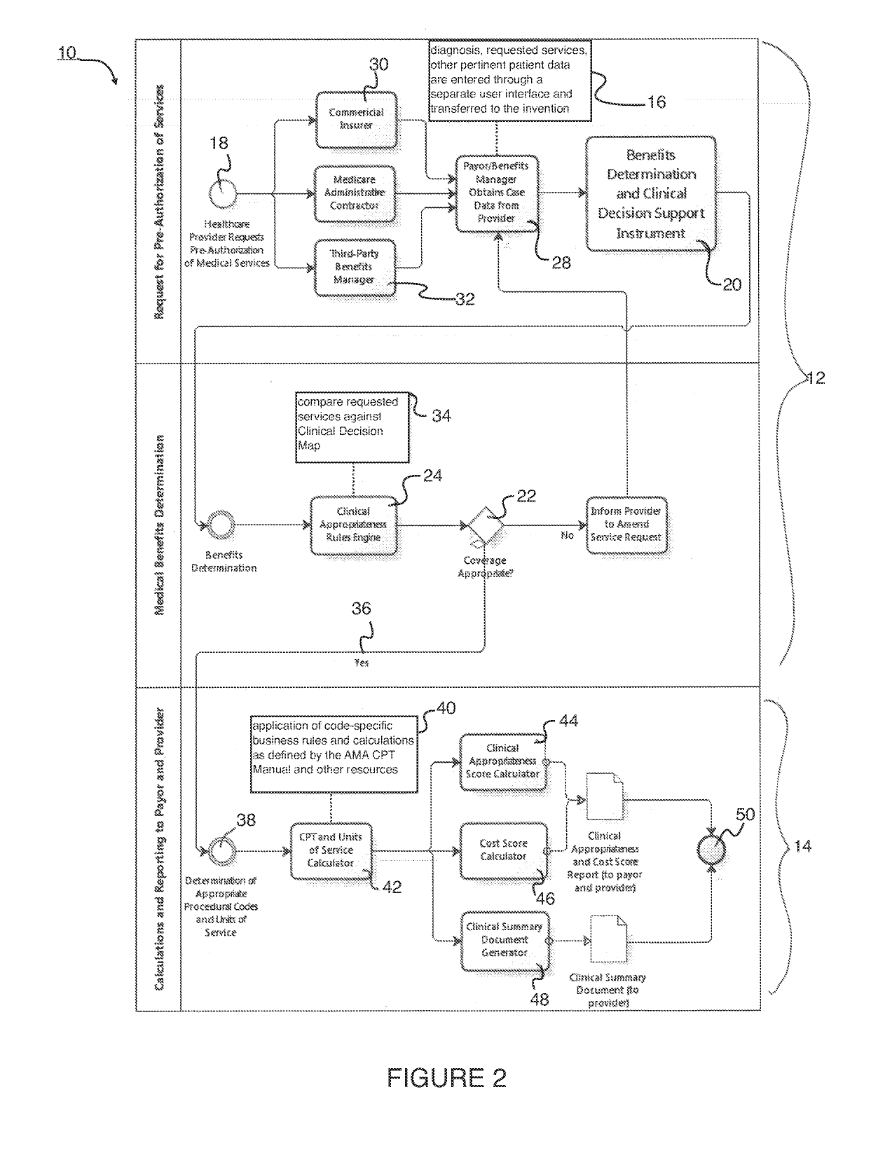

Additionally referring to FIG. 2, in one embodiment the analytic phase 12 utilizes one or more patient information variable (or data) 16 relating to medical condition(s) and one or more proposed specific medical management (i.e., requested medical services 18). The patient information variable 16 is used to select the appropriate stored clinical and coding databases 23 of a benefits/decision support and determination instruments 20, 20′ against which clinical appropriateness comparisons 22 will be made utilizing rules engines 24.

A set of rules engines 24 governs the results of the analytic phase 12. As explained above, the system 10 receives the patient information variable(s) 16 from a user interface 26 that may be furnished to the healthcare provider 28 by the patient's insurer 30 or benefits manager 32, an electronic health record system, or other third-party software vendor.

Alternatively, the patient information variable(s) 16 are queried, through the rules engines 24 and programming code that calls up a series of questions from the database 23 containing prepared questions related to (a) the stated disease or medical condition, (b) the proposed specific medical management and (c) other health-related patient factors to be presented to and answered by a user through the user interface. The programming code generates the series of questions in an iterative fashion such that an answer to a given question governs the selection of a subsequent question. The programming code then determines a terminal question among the series of questions and subsequently infers a proposed specific medical management on the basis of user-input answers to the preceding series of questions.

Patient information variable(s) 16 include specific information pertinent to the patient's medical condition or disease, medical history and prior procedures, and other clinical factors as necessary to render a coverage decision. The system 10 stores clinical and coding support databases 23 that can be modified according to specific insurer and benefits manager policies and according to updates of clinical practice guidelines. Clinical support databases include guidelines for the treatment of health conditions according to medical specialty society best clinical practice guidelines, consensus expert group recommendations and medical literature references of high-quality evidence from published clinical research studies. Coding support databases contain information abstracted from the American Medical Association Common Procedural Terminology Manual, published specialty society coding guidelines, and insurer-specific coding guidance.

Each requested medical service 18, also referred to as proposed specific medical management, is assessed for clinical appropriateness using a clinical decision map 34. The clinical decision map 34 is a programmable schematic of the insurer's or benefits manager's medical coverage policy, is unique for every different covered diagnosis, and segregates all possible medical services into indicated and contraindicated groups. The required inputs for selecting the appropriate clinical decision map 34 are clinical variables about the specific case. For example, the invention would rule out the use of surgery for the treatment of leukemia, using the clinical decision may 34 as the basis of its clinical appropriateness rules engine 24.

For instance, the system 10 queries the database 23 of pre-defined clinically appropriate medical managements for the stated disease or medical condition and accordingly assigns a status indicator of either ‘Approved’ or ‘Denied’ to the proposed specific medical management provided through the user interface 26 that may be furnished to the healthcare provider 28 by the patient's insurer 30 or benefits manager 32, an electronic health record system, or other third-party software vendor.

If the status indicator of one or more proposed specific medical management is approved, the database 23 is queried for a pre-defined clinically appropriate medical management and assigns the pre-defined appropriateness score to the proposed specific medical management. The database 23 may also be queried for other pre-defined clinically appropriate medical managements for the given medical condition and the system 10 displays the other pre-defined clinically appropriate medical managements and corresponding pre-defined appropriateness scores as additional treatment options.

If the status indicator of one or more proposed specific medical management is denied, the database 23 is queried for pre-populated statements of denial and displays the same. Additionally, the system 10 may return the user to the question for which the user's answer resulted in the assignment of a ‘Denied’ status indicator to the proposed specific medical management as an opportunity to provide an alternate answer in order to gain “Approved’ status.

Once a requested medical service/proposed specific medical management 18 has been deemed as appropriate 36 for a given medical condition, the system 10 selects the correct procedural codes associated with the performance of the medical service and calculates the correct units of service per code 38. The database 23 structure allows for the storage of one or more valuation information, payment information, procedure costs, and alternative procedure costs pertaining to said medical and technical procedures and allows for the addition and exchange of different fee schedules.

The system 10 calculates a cost of each procedure using valuation or payment information called up from the database 23 structure and calculates the overall cost for the entire proposed specific medical management, also referred to as the ‘Cost Score’. Furthermore, the system 10 contains an organizational, structure that segregates procedures determined by the rules engine and their related costs according to clinically logical groups, such as but not limited to, Pre-Treatment Procedures, intra-treatment Procedures and Post-Treatment Procedures groups, and outputs same. Also, the patient information variable(s) 16 can be changed in the system 10 and the process repeated for determination and calculation of all procedures and costs.

Procedural codes describe specific medical procedures and are defined by the American. Medical Association Common Procedural Terminology Manual. These codes constitute the set of billable units that the healthcare provider may invoice the insurer for payment of services for the patient policyholder. For each procedural code, a set of business rules and calculations 40 exists to account for relationships with other related services—such as bundling of charges—and to accurately determine the correct number of billable units for a specific case. For instance, fixed treatment, disease and patient information variables for a medical management of a specified disease or medical condition can by input into the system 10 in order to determine a set of medical and technical procedures and calculate their related costs and the fixed overall cost for the proposed specific medical management under an Episodic Payment, Bundled Payment, or Capitated Payment reimbursement system.

Once a determination of benefits has been made 42 in a case, the system 10 then makes an objective assessment of the relative costs and clinical appropriateness of other medical services (also known as alternative pre-defined clinically appropriate medical managements) that would have otherwise been appropriate clinical choices for the case. The invention calculates two separate scores of merit: a clinical appropriateness score 44 and a cost score 46 (also known as valuation information). The clinical appropriateness score 44 compares the requested medical service/proposed specific medical management 18 against other appropriate services (i.e., pre-defined clinically appropriate medical managements) for a given case with the intent of informing the insurer and provider of the relative clinical utility of the requested service. For example, the provider may be notified that his requested service returned a clinical appropriateness score 44 of five on a scale of one to ten, whereas another service for the same case has a clinical appropriateness score 44 of nine. This clinical appropriateness score 44 is based on clinical management guidance statements and pre-defined appropriateness scores from medical specialty societies and other consensus groups as well as the observations of utilization of those services within the insurer's claims database. The cost score 46 likewise draws comparisons between requested and other appropriate services but on the basis of relative costs and/or procedure costs versus alternative procedure costs. For example, the insurer may be informed that service A will cost twice as much as service B but with similar clinical appropriateness scores 44.

Turning to the reporting phase 14, the system 10 determines or denies the authorization of requested medical services 18 for a given case and employs a separate set of rules engines 24 to generate a narrative summary 48 and technical statements of the clinical and coding guidance used in the adjudication of the coverage decision; to prepare technical statements related to the appropriate coding and billing of the procedures and their corresponding units of service outputted from the Benefits Determination Instrument 20′, to produce a corresponding list of medical references to the medical literature and procedural coding guidance materials supporting the prepared statements; to prepare ‘Standard of Care’ and other clinical statements related to the appropriateness of the specific medical management output of the Clinical Decision Support Instrument 20, and to construct a tabular and graphical display of comparative metrics pertaining to procedures and cost 46 (including billing procedures), clinical appropriateness score 44 and overall utilization of the requested services versus alternative services for the stated medical condition and necessary medical procedure(s) of the case. Outputs from the Clinical Decision Support Instrument 20 and the Benefits Determination Instrument 20′ can be compiled by the system 10 into a coherent set of reports for the anticipated end users, including healthcare providers, healthcare insurer or payors, and third-party benefits managers 50.

To address a common complaint from the healthcare provider community that medical coverage decisions lack transparency, the system 10 optionally auto-generates a documented summary of the coverage decision 48 with a supporting narrative complete with corresponding citations of the medical literature and other information sources for the provider's review. This document serves to educate the provider of standard-of-care medical and coding practices for a given diagnosis and medical management strategy.

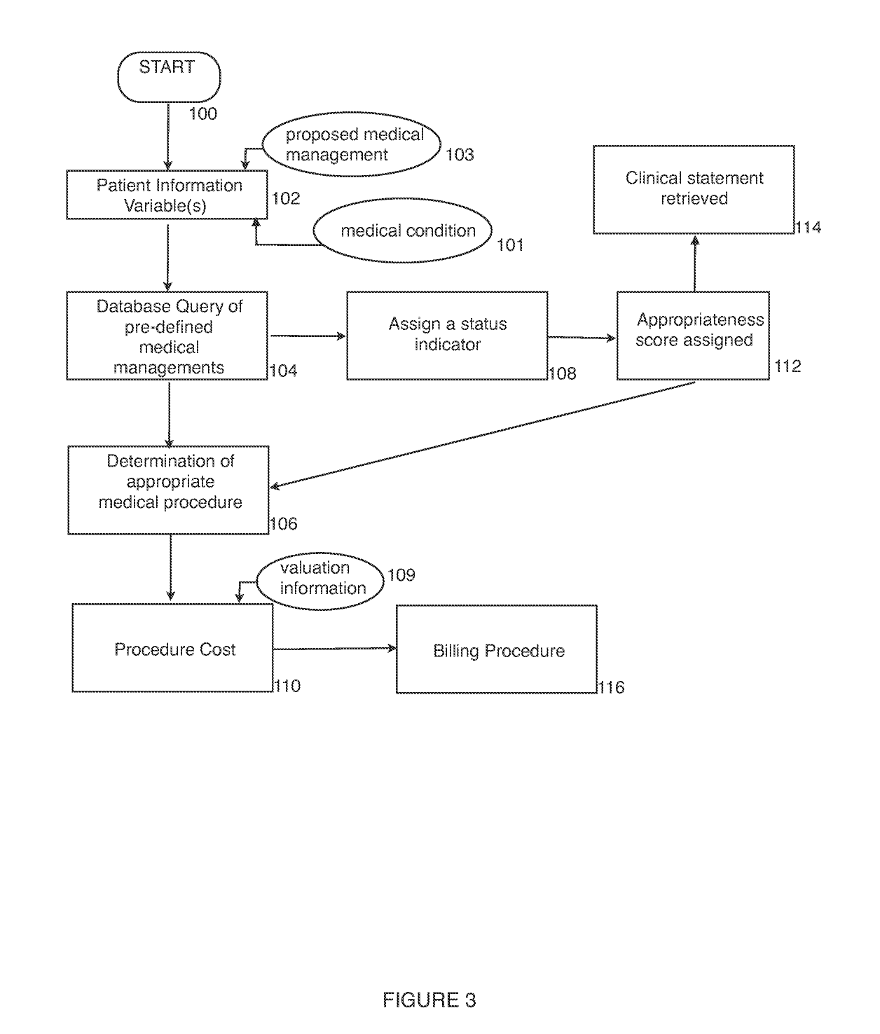

With reference to FIG. 3, an exemplary computer-based method of determining clinical appropriateness and medical benefits for one or more proposed specific medical management of a medical condition, and the reporting of procedural and cost-related information for the same, is shown. For illustrative purposes, multiple steps and alternative steps are descried in connection with a single iteration of the method being performed in connection with a user having full access to every system function. However, it will be appreciated that not every step would be necessary for every iteration of the method, that the method could be performed in interaction with other, more limited users, and that all or part of the method could be repeated, as desired. Additionally, steps are not necessarily performed in the order described, and any logical order can be used, including the simultaneous performance of multiple steps. Also, the system described herein is adapted to carry out each of the steps described by the method.

The method begins at block 100. At block 102, one or more patient information variable is received from a user by the system (e.g., patient, health care provider, or insurance provider). The patient information variable includes at least the medical condition 101 and the one or more proposed specific medical management 103. At block 104, a database is queried by the system, the database comprising pre-defined clinically appropriate medical managements for the medical condition, and the pre-defined clinically appropriate medical managements including at least an appropriateness score. At block 106, the patient information variable(s) are associated with one or more pre-defined clinically appropriate medical managements to determine one or more appropriate medical procedure for rendering the proposed specific medical management and/or, at block 108, to assign a status indicator to the specific medical management. One or more valuation information (block 109) is associated with the one or more appropriate medical procedure to obtain a procedure cost (block 110). An appropriateness score (block 112) is assigned to the specific medical management based on the status indicator and the pre-defined clinically appropriate medical managements. The patient information variable, the pre-defined clinically appropriate medical managements, and the appropriateness score are associated to determine one or more appropriate medical procedure (block 106) for rendering a or more proposed specific medical management. The database is queried for a clinical statement (block 114) related to the appropriateness score and the or more proposed specific medical management. The database is then queried for one or more billing procedures (block 116) based on the procedure cost and/or one or more medical reference supporting the clinical statement, and the billing procedure is displayed.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A computer-based method for determining clinical appropriateness of at least one proposed specific medical management for a medical condition, the method being executed by at least one network-connected computer including a processor and machine readable memory, the method comprising:
querying a database comprising pre-defined clinically appropriate medical managements for at least one patient information variable including a medical condition, the pre-defined clinically appropriate medical managements including a pre-defined appropriateness score;
associating the pre-defined clinically appropriate medical managements with the at least one proposed specific medical management to assign a status indicator to the at least one proposed specific medical management;
assigning an appropriateness score to the at least one proposed specific medical management based on criteria comprising the status indicator and pre-defined clinically appropriate medical managements.

2. The method of claim 1, wherein one of the status indicators is whether the at least one proposed specific medical management is approved, and the database is queried for the pre-defined clinically appropriate medical management and assigns the pre-defined appropriateness score to the at least one proposed specific medical management it the at least one proposed specific medical management is approved.

3. The method of claim 1, wherein one of the status indicators is whether the at least one proposed specific medical management is approved, and the database is queried for alternative pre-defined clinically appropriate medical managements for the given medical condition and displays the alternative pre-defined clinically appropriate medical managements and corresponding pre-defined appropriateness scores as additional treatment options.

5. The method of claim 1, wherein one of the status indicators is whether the at least one proposed specific medical management is denied, and the database is queried for pre-populated statements of denial and displays the pre-populated statements of denial.

6. The method of claim 1, further comprising displaying the appropriateness score assigned to the at least one proposed specific medical management.

7. The method of claim 2, further comprising querying the database for at least one medical procedures associated with proposed specific medical management and displaying the at least one medical procedures.

8. The method of claim 3, further comprising querying the database for at least one medical procedures associated with alternative pre-defined clinically appropriate medical managements and displaying the at least one medical procedures.

9. The method of claim 7, further comprising associating at least one valuation information with the at least one medical procedures associated with the at least one proposed specific medical management to obtain at least one procedure cost.

10. The method of claim 8, further comprising associating at least one valuation information with the at least one medical procedures associated with the alternative pre-defined clinically appropriate medical managements to obtain at least one alternative procedure cost.

11. A computer-based method for determining medical benefits necessary for the treatment of a medical condition, the method being executed by at least one network-connected computer including a processor and machine readable memory, the method comprising:
associating a patient information variable with at least one pre-defined clinically appropriate medical managements to determine at least one appropriate medical procedure for rendering an at least one proposed specific medical management; and
associating at least one valuation, information with the at least one appropriate medical procedure to obtain a procedure cost.

12. The method of claim 11, wherein the procedure cost includes total costs associated with all of the at least one appropriate medical procedures for rendering an at least one proposed specific medical management.

13. The method of claim 11, further comprising displaying at least one appropriate medical procedure and associated procedure cost for rendering an at least one proposed specific medical management.

14. The method of claim 13, wherein the at least one appropriate medical procedure comprises pre-treatment procedures, intra-treatment procedures and post-treatment procedures.

15. A computer-based method for reporting procedural and cost-related information for at least one proposed specific medical management of a medical condition, the method being executed by at least one network-connected computer including a processor and machine readable memory, the method comprising:
querying a database comprising pre-defined clinically appropriate medical managements for at least one patient information variable, which includes the medical condition, the pre-defined clinically appropriate medical managements including an appropriateness score;
associating the pre-defined clinically appropriate medical managements with the at least one proposed specific medical management to assign a status indicator to the specific medical management;
assigning an appropriateness score to the specific medical management based on the status indicator and the pre-defined clinically appropriate medical managements;
querying the database for a clinical statement related to the appropriateness score and the at least one proposed specific medical management.

16. The method of claim 15, further comprising associating the patient information variable, the pre-defined clinically appropriate medical managements, and the appropriateness score to determine at least one appropriate medical procedure for rendering an at least one proposed specific medical management, and
associating at least one valuation information with the at least one appropriate medical procedure to obtain a procedure cost.

17. The method of claim 16, further comprising querying the database for and displaying at least one billing procedures based on the procedure cost.

18. The method of claim 15, further comprising querying the database for and displaying at least one medical reference supporting the clinical statement.

19. The method of claim 17, further comprising querying the database for and displaying at least one medical reference supporting the billing procedures.

20. A computer-based system for reporting procedural and cost-related information for at least one proposed specific medical management of a medical condition, the system comprising at least one network-connected computer including a processor and machine readable memory configured to:
associate pre-defined clinically appropriate medical managements for the medical condition, which include an appropriateness score, with a patient information variable, the patient information variable including the medical condition and at least one proposed specific medical management, to assign a status indicator to the at least one proposed specific medical management;
assign an appropriateness score to the at least one proposed specific medical management based on the status indicator and the pre-defined clinically appropriate medical managements;
display clinical statement related to the appropriateness score and the at least one proposed specific medical management.
